(19) United States
(12) Patent Application Publication
(10) Pub. No.: US 2025/0307521 A1
(43) Pub. Date: Oct. 2, 2025

(54) METHOD FOR PROCESS FINE TUNING BASED ON COMPUTER SIMULATIONS

(71) Applicant: Tokyo Electron Limited, Tokyo (JP)

(72) Inventors: Sergey AVERKIN, Albany, NY (US); Pingshan LUAN, Albany, NY (US); Daishiro AKIYAMA, Albany, NY (US); Daiki KAWAHITO, Sapporo City (JP); Yusuke LENT-YOSHIDA, Albany, NY (US)

(73) Assignee: Tokyo Electron Limited, Tokyo (JP)

(21) Appl. No.: 18/622,260

(22) Filed: Mar. 29, 2024

(51) Int. Cl. G06F 30/398; G06F 119/18

(52) U.S. Cl. CPC G06F 30/398; G06F 2119/18

(57) ABSTRACT

Aspects of the present disclosure provide a method for using simulation techniques to find simulation uncertainties for specific process conditions for a semiconductor process. For example, the method can include receiving a simulation model related to a semiconductor process, receiving one or more input data related to the semiconductor process, assigning uncertainty to each of the input data, running the simulation model on the input data assigned with the uncertainties to obtain simulation results, comparing the simulation results with experimental measurements, calibrating the simulation model based on comparing the simulation results with the experimental measurements, and running an optimization process with input uncertainties to obtain an allowable area of optimum parameters.

### FIELD OF THE INVENTION

The present disclosure relates to semiconductor manufacturing, and, more particularly, to methods for process fine tuning based on computer simulations.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Material processing in the semiconductor industry presents formidable challenges in the manufacture of integrated circuits (ICs). Demands for increasing the speed of ICs in general, and memory devices in particular, force semiconductor manufacturers to make devices smaller and smaller on the substrate surface. Moreover, in order to reduce fabrication costs, it is necessary to reduce the number of steps (e.g., etch steps, deposition steps, etc.) required to produce an IC structure and hence reduce the overall complexity of the IC structure and the fabrication methods thereof. These demands are further exacerbated by both the reduction in feature size and the increase of substrate size (i.e., 200 mm to 300 mm and greater) which places greater emphasis on the precise control of critical dimensions (CD), process rate, and process uniformity to maximize the yield of superior devices.

In semiconductor manufacturing, numerous steps during the evolution of ICs are employed including vacuum processing, thermal processing, plasma processing, etc. Within each processing step, numerous variables (e.g., operating conditions) are present that affect the outcome of the process. In order to more precisely control the outcome of each processing step, e.g., the plasma processing, the respective semiconductor processing tools are equipped with an increasing number of diagnostic systems (electrical, mechanical, and optical) to measure data, e.g., rate constants and densities of plasma species, during plasma processing (or plasma chemistry process) and provide an intelligent basis for correcting process variations through the actions of a process controller (e.g., a processor). The number of diagnostic systems is becoming burdensome and costly. Yet, data sufficiently resolved in space and time for complete process control is still not available.

These industry and manufacturing challenges have led to interest in more use of computer-based modeling and simulation in the semiconductor manufacturing industry. Computer-based modeling and simulation are increasingly being used for prediction of, for example, tool performance during the semiconductor manufacturing tool design process and the densities of plasma species during the plasma processing. Modeling in many disciplines, such as stress, thermal, magnetics, etc., has reached a level of maturity where it can be trusted to provide accurate answers to design questions. Moreover, computer power has been increasing rapidly along with the development of new solution algorithms, both of which resulted in reduction of time required to obtain a simulation result.

### SUMMARY

Aspects of the present disclosure provide a method for using simulation techniques to find simulation uncertainties for specific process conditions for a semiconductor process. For example, the method can include receiving a simulation model related to a semiconductor process, receiving one or more input data related to the semiconductor process, assigning uncertainty to each of the input data, running the simulation model on the input data assigned with the uncertainties to obtain simulation results, comparing the simulation results with experimental measurements, calibrating the simulation model based on comparing the simulation results with the experimental measurements, and running an optimization process with input uncertainties to obtain an allowable area of optimum parameters. In an embodiment, running the optimization process with input uncertainties to obtain the allowable area of optimum parameters is executed more than one time to produce the allowable area of optimum parameters.

In an embodiment, the simulation results can be represented by a simulation error bar that is determined according to a simulation mean and a simulation variance of the simulation results, the experimental measurements can be represented by an experimental error bar that is determined according to an experimental mean and an experimental variance of the experimental results, and the simulation model can be calibrated based on a relationship of the simulation error bar with the experimental error bar. For example, the simulation model can be calibrated when the simulation error bar does not overlap with the experimental error bar. As another example, the simulation model can be calibrated when a difference between the simulation mean and the experimental mean is greater than a predetermined mean threshold. As yet another example, the simulation model can be calibrated when the simulation variance is greater than a predetermined variance threshold.

In an embodiment, the semiconductor process can be a semiconductor manufacturing process, the input data can be a rate constant or electron collision cross-section of a plasma reaction that takes place during the semiconductor manufacturing process, chamber geometry, and/or input conditions, the simulation results can be a specie density of the plasma species that evolves in time under certain plasma conditions of the semiconductor manufacturing process, temperatures of plasma species, and/or distribution functions, and the experimental results can be characterized by using optical emission spectroscopy (OES) or Langmuir probe diagnostics. In some embodiments, the rate constant can be a value sampled randomly from a predetermined distribution that characterizes the rate constant of the plasma species. For example, the rate constant can be characterized by a log-normal distribution. As another example, the predetermined distribution is characterized by an upper threshold and a lower threshold, and the rate constant is sampled randomly within a range of the predetermined distribution that is limited by the upper threshold and the lower threshold. As yet another example, calibrating the simulation model can include adjusting a range of the predetermined distribution that the value is sampled randomly therewithin.

In an embodiment, the method can further include determining optimum plasma conditions of the simulation model for the simulation results that are in quantitative agreement with the experimental measurements. In some embodiments, the optimum plasma conditions can be determined by assigning uncertainties to the certain plasma conditions of the simulation model, running the simulation model using the certain plasma conditions assigned with the uncertainties to obtain optimum simulation results, and comparing the optimum simulation results with optimum experimental measurements. For example, the optimum plasma conditions can include concentration of electrons, ions, atomic and molecular gases, temperatures, distribution functions and/or flow rates in the semiconductor manufacturing process. As another example, the optimum plasma conditions can include operating power of the semiconductor manufacturing process. As yet another example, the optimum plasma conditions can include a duty cycle of the operating power.

In an embodiment, receiving the one or more input data, assigning the uncertainty to each of the input data and running the simulation model can be executed iteratively more than one time. In another embodiment, receiving the simulation model and receiving the one or more input data can be executed simultaneously. In some embodiments, receiving the simulation model can be executed following receiving the one or more input data. Alternatively, receiving the one or more input data can be executed following receiving the simulation model.

Aspects of the present disclosure further provide a non-transitory machine-readable storage medium including instructions which, when executed by a processor, cause the processor to execute a method. For example, the method can include receiving a simulation model related to a semiconductor process, receiving one or more input data related to the semiconductor process, assigning uncertainty to each of the input data, running the simulation model on the input data assigned with the uncertainties to obtain simulation results, comparing the simulation results with experimental measurements, and calibrating the simulation model based on comparing the simulation results with the experimental measurements.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a functional block diagram of a computer-based modeling and simulation system in accordance with some embodiments of the present disclosure;

FIG. 2 is a flow chart showing a method for using simulation techniques to facilitate a semiconductor process performed by a semiconductor processing tool in accordance with some embodiments of the present disclosure;

FIG. 3 shows some of essential components of uncertainty quantification;

FIG. 4 is a functional block diagram of a computer-based modeling and simulation system in accordance with some embodiments of the present disclosure;

FIG. 5 is a flow chart showing a method for using simulation techniques to find simulation uncertainties for specific process conditions for a semiconductor process in accordance with some embodiments of the present disclosure;

FIG. 6 shows two input parameters that are controlled independently to find all optimum parameters;

FIG. 7 shows an application example illustrating the simulation of a plasma species density for different radicals in accordance with some embodiments of the present disclosure;

FIG. 8A shows different pulse duty cycles of power supplied to a plasma chemistry process; and

FIG. 8B shows the species densities of a variety of plasma species during the plasma chemistry process when different pulse duty cycles of power are supplied.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

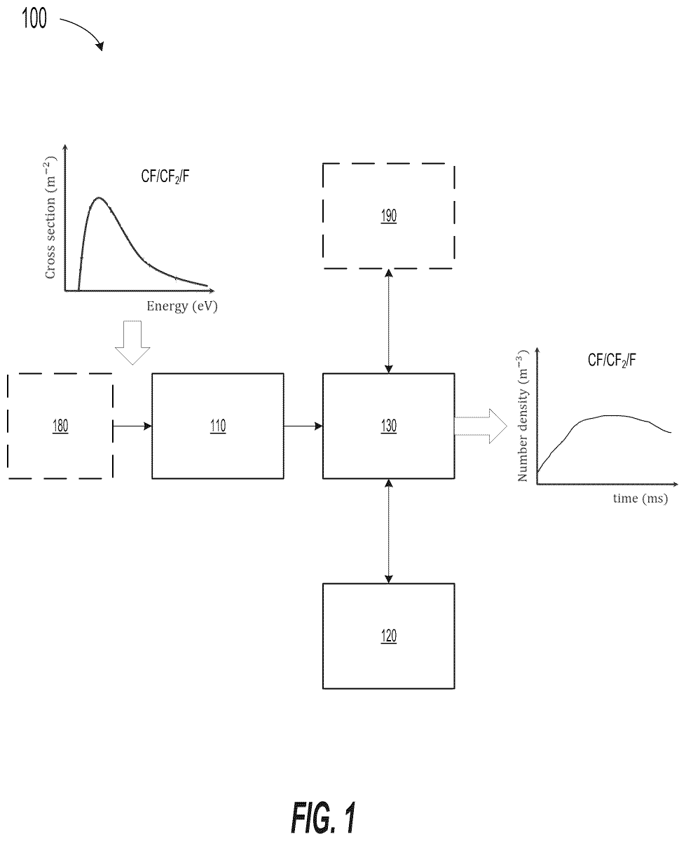

FIG. 1 is a functional block diagram of a computer-based modeling and simulation system 100 in accordance with some embodiments of the present disclosure. The computer-based modeling and simulation system 100 can use simulation techniques to predict, for example, tool performance during a semiconductor process (e.g., a manufacturing tool design process) and densities (numbers/m⁻³) of plasma species during a plasma chemistry process (or thermal chemical processes or any other semiconductor manufacturing processes). As shown in FIG. 1, the computer-based modeling and simulation system 100 can include a data input device 110, a physical (or simulation such as computational or mathematical) model (e.g., a plasma chemistry (simulation) model) 120, and a simulation processor 130. In an embodiment, the computer-based modeling and simulation system 100 can further include a processing tool 180.

The processing tool 180 can be used to perform a semiconductor process related to manufacturing an integrated circuit or a semiconductor wafer. For example, the processing tool 180 may be implemented as a material processing system, an etch system, a photoresist spin coating system, a lithography system, a dielectric coating system (i.e., a spin-on-glass (SOG) or spin-on-dielectric (SOD) system), a deposition system (i.e., a chemical vapor deposition (CVD) system or a physical vapor deposition (PVD) system), a rapid thermal processing (RTP) system for thermal annealing, a batch diffusion furnace, or any other tool for performing a semiconductor process.

The data input device 110 can be a device for collecting data (e.g., rate constant of plasma reactions or electron collision processes with gases such as CF, CF₂, F, etc. during a plasma chemistry process) relating to a semiconductor process (that may be performed by the processing tool 180) and inputting the collected data to the simulation processor 130. The semiconductor process performed by the processing tool 180 may be a characterization process (i.e., process design or development), a cleaning process, a production process, or any other process performed by the processing tool 180. In an embodiment, the data input device 110 may be implemented as a physical sensor for collecting data about the processing tool 180 itself, and/or the environment contained within a chamber of the tool. Such data may include fluid mechanic data such as gas velocities and pressures at various locations within the process chamber, electrical data such as voltage, current, and impedance at various locations within the electrical system of the process chamber, chemical data such as rate constants, species concentrations and reaction chemistries at various locations within the process chamber, thermal data such as gas temperature, surface temperature, and surface heat flux at various locations within the process chamber, plasma processing data (when plasma is utilized) such as a plasma density (obtained, for example, from a Langmuir probe), an ion energy (obtained, for example, from an ion energy spectrum analyzer), and mechanical data such as pressure, deflection, stress, and strain at various locations within the process chamber.

In addition to the tool and tool environment data, the data input device 110 may collect data relating to the semiconductor process itself, or semiconductor process results obtained on a semiconductor wafer that the processing tool 180 is performing a semiconductor process on. In an embodiment, the data input device 110 can be implemented as a metrology tool coupled to the processing tool 180. The metrology tool may be configured to measure process performance parameters such as etch rate, deposition rate, etch selectivity (ratio of the rate at which a first material is etched to the rate at which a second material is etched), an etch critical dimension (e.g., length or width of feature), an etch feature anisotropy (e.g., etch feature sidewall profile), a film property (e.g., film stress, porosity, etc.), a mask (e.g., photoresist) film thickness, a mask (e.g., photoresist) pattern critical dimension, or any other parameters of a semiconductor process performed by the processing tool 180.

The data input device 110 may be directly coupled to the processing tool 180 and the simulation processor 130 to automatically receive data from the processing tool 180 and forward this data to the simulation processor 130, as shown in FIG. 1. Alternatively, the data input device 110 may be implemented as a user input device used to indirectly provide data relating to a semiconductor process performed by the processing tool 180 to the simulation processor 130. For example, the data input device 110 may be a keyboard that a simulation operator uses to input data into the simulation processor 130. Still alternatively, the data input device 110 may be a database for storing data relating to semiconductor processes performed in the past by the processing tool 180. In this embodiment, the database may be populated automatically by use of a physical sensor or metrology tool coupled to the processing tool 180, and/or by manual input. In some embodiments, the database may be automatically accessed by the simulation processor 130 to input the data to the simulation processor 130.

The physical model 120 can be a model of the physical attributes of the tool and tool environment as well as the fundamental equations necessary to perform a simulation (e.g., a plasma chemistry simulation) and provide a simulation result (e.g., densities of plasma species) for facilitating a semiconductor process performed by the processing tool 180. Thus, the physical model 120 can depend to some extent on the type of processing tool 180 analyzed as well as the semiconductor process performed in the processing tool 180. For example, the physical model 120 may include a spatially resolved model of the physical geometry of the processing tool 180, which is different, for example, for a chemical vapor deposition (CVD) chamber and a diffusion furnace. The physical model 120 may be a model as implemented in commercially available software, such as ANSYS, of ANSYS Inc., Southpointe, 275 Technology Drive Canonsburg, Pa. 15317, or COMSOL by COMSOL, Inc, 100 District Ave., Burlington, MA 01803, to compute flow fields, electromagnetic fields, temperature fields, chemistry, surface chemistry (i.e., etch surface chemistry or deposition surface chemistry).

The simulation processor 130 can be a processing device that applies data (e.g., rate constants of plasma species) input from the data input device 110 to the physical model (e.g., a plasma chemistry model) 120 to execute a certain simulation. In an embodiment, the simulation processor 130 may use the data provided by the data input device 110 to set initial conditions and/or boundary conditions for the physical model 120, which is then executed by the simulation processor 130. The simulations in the present disclosure may include, but are not limited to, simulations of electromagnetic fields derived from Maxwell's equations, continuum simulations, for example, for mass, momentum, and energy transport derived from continuity, the Navier-Stokes equation and the First Law of Thermodynamics, as well as atomistic simulations derived from the Boltzmann equation, such as for example direct simulations Monte Carlo (DSMC) of rarefied gases (see Bird, G. A. 1994. Molecular gas dynamics and the direct simulation of gas flows, Clarendon Press) or Particle-In-Cell method (see Birdsall C. K., Langdon A. B. 2018. Plasma physics via computer simulation. CRC press). The simulation processor 130 may be implemented as a processor or workstation physically integrated with the processing tool 180, or as a general purpose computer system such as a computer system. The output of the simulation processor 130 can include a simulation result that is used to facilitate a semiconductor process performed by the processing tool 180. For example, the simulation result may be used to facilitate process development, process control and fault detection as well as to provide virtual sensor outputs that facilitate tool processes.

As shown in FIG. 1, the computer-based modeling and simulation system 100 may also include a tool-level library 190 for storage of simulation results (e.g., the densities of plasma species). The tool-level library 190 can be essentially a compilation of results of past simulations that may be used to provide simulation results in the future. The tool-level library 190 may be stored in a separate storage device or in a computer storage device, such as a hard disk, integrated with the simulation processor 130.

It is to be understood that the computer-based modeling and simulation system 100 in FIG. 1 is for exemplary purposes only, as many variations of the specific hardware and software used to implement the present disclosure will be readily apparent to one having ordinary skill in the art. For example, the functionality of the physical model 120, the simulation processor 130 and the tool-level library 190 may be combined in a single device. Similarly, the functionality of the data input device 110 may be combined with the functionality of the processing tool 180 and/or the simulation processor 130. To implement these variations as well as other variations, a single computer may be programmed to perform the special purpose functions of two or more of the devices shown in FIG. 1. On the other hand, two or more programmed computers may be substituted for one of the devices shown in FIG. 1. Principles and advantages of distributed processing, such as redundancy and replication, may also be implemented as desired to increase the robustness and performance of the system, for example.

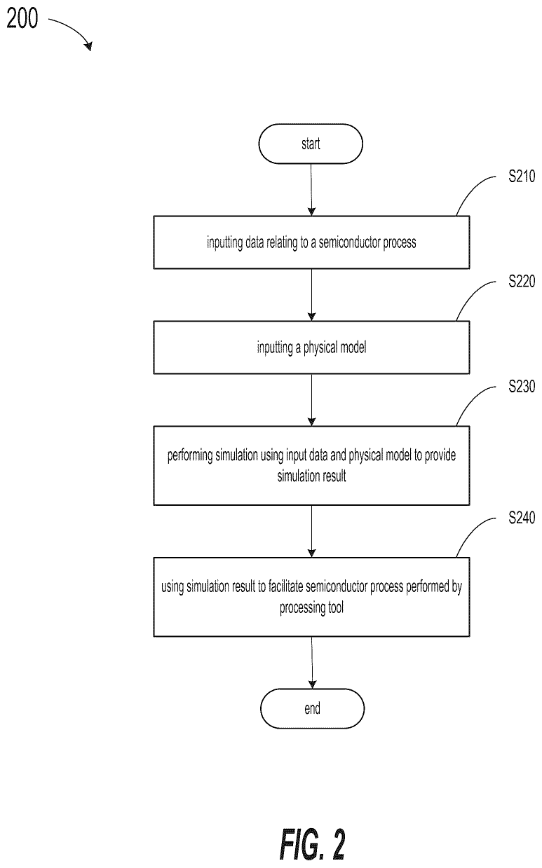

FIG. 2 is a flow chart showing a method 200 for using simulation techniques to facilitate a semiconductor process performed by a semiconductor processing tool in accordance with some embodiments of the present disclosure. The method 200 shown in FIG. 2 may be run on the simulation processor 130 of FIG. 1, for example. As shown in FIG. 2, the method 200 can start in step S210 with the inputting of data related to a semiconductor process performed by the processing tool 180. As discussed above, the input data may be data relating to physical attributes of the tool/tool environment and/or data relating to a semiconductor process performed by the processing tool 180 on a semiconductor wafer or results of such semiconductor process. As also described above, the input data may be directly input from a physical sensor or metrology tool coupled to the simulation processor 130, or indirectly input from a manual input device or database. Where the data is indirectly input by manual input device or a database, the data may be data that was recorded from a previously run semiconductor process, such as sensor data from a previously run process. Alternatively, the data may be set by the simulation operator as “best known input parameters” for the particular simulations, which may or may not relate to the data collected during a semiconductor process. The type of input data input by the processing tool 180 generally depends on the desired simulation result.

In addition to inputting the input data, the physical model 120 can also be input to the simulation processor 130, as shown in step S220. Step S220 can include inputting the physical attributes of the tool modeled by the physical model 120, as well as equations codified in software necessary to perform a simulation (e.g., a plasma chemistry simulation) of a desired attribute of the process performed by the processing tool 180. The physical model 120 may be input to the simulation processor 130 from an external memory or an internal memory device integral to the simulation processor 130. Moreover, while step S220 is shown in FIG. 2 as following step S210, it is to be understood that the simulation processor 130 may perform steps S210 and S220 simultaneously or in reverse of the order shown in FIG. 2.

In step S230, the simulation processor 130 can use the input data (e.g., rate constants of plasma species) of step S210 and the physical model (e.g., a plasma chemistry model) 120 of step S220 to execute a simulation (e.g., a plasma chemistry simulation) and provide a simulation result (e.g., the densities of plasma species). In an embodiment, the input data can be rate constants of plasma reactions, which can be determined by the convolution of a cross section (m⁻²) with the energy or speed of the reacting species, and the simulation result can be the densities of plasma species (number/m⁻³) with respect to discharging time of the reacting species. Step S230 may be performed either concurrently with or not concurrently with the semiconductor process performed by the processing tool 180. For example, simulations that can be performed at short solution times may be run concurrently with a tool process of the processing tool 180, and a simulation result (e.g., the densities of plasma species) may be used to control the semiconductor process. More computationally intensive simulations may be performed not concurrently with the tool process and the simulation result may be stored in a library, e.g., the tool-level library 190, for later retrieval. In an embodiment, step S230 can include using the input data of step S210 to set initial and/or boundary conditions for the physical model 120 provided in step S230.

Once the simulation is finished, the simulation result can be used to facilitate a semiconductor process performed by the processing tool 180, as shown in step S240. As used herein, the term “facilitate a semiconductor process performed by the semiconductor processing tool” can include using the simulation result for example to detect a fault in the semiconductor process, to control the semiconductor process, to characterize the semiconductor process for manufacturing runs, to provide virtual sensor readings relating to the semiconductor process, or any other use of the simulation result in conjunction with facilitating a semiconductor process performed by the processing tool 180.

In a plasma chemistry process, a variety of uncertainties may be introduced, such as uncertainty about the model form (e.g., the physical model 120), numerical uncertainty (or computational errors) in the solution procedure, and uncertainty regarding model inputs (or input data, e.g., rate constants of plasma reactions), all of which lead to uncertainty in the model output (or simulation results, e.g., the densities of the plasma species). Uncertainty about the model form (also known as model bias or discrepancy) may be introduced since the mathematical models (e.g., the physical model 120) that the simulation processor 130 tries to simulate is only an approximation to the true underlying physics. Numerical uncertainty may associate with the accuracy of the codes used to simulate the mathematical models, and may be induced by discretization errors, truncation errors, iterative errors, round-off (or convergence) errors, and bugs or the coding errors. Uncertainty regarding model inputs may include geometry uncertainty (e.g., induced by manufacturing tolerance, simplified geometry when executing the simulation, etc.), model parameter uncertainty (which is induced due to variation of plasma species), boundary condition uncertainty (which is induced due to the random nature of the plasma chemistry process), and initial condition uncertainty (which may be partially inferred due to the limited observations and measuring accuracy).

In general, the uncertainties can be classified into aleatory uncertainty and epistemic uncertainty. The aleatory uncertainty arises dues to inherent variation or randomness of a quantity of interest (QoI). Currently, the aleatory uncertainty cannot be reduced by collecting more information, and the parameters of a model may be best represented with probability distributions. Epistemic uncertainty arises due to the lack of knowledge, which may come from inadequate understanding of the plasma processing, incomplete knowledge of the phenomena, and imprecise evaluation of the related characteristics, and may be reduced if sufficient knowledge is gained (e.g., via experiments).

The uncertainties can form primary obstacles for the predictive capability of the computer-based modeling and simulation system 100, e.g., deviating the simulation results from the true underlying physical process. Hence, it is important to quantify the errors thus induced in order to be able to correctly interpret the simulation results, which may include identifying the dominant sources of uncertainties, analyzing how uncertainties propagate in the plasma processing, and finding stable optimized solutions across a wide range of inputs, and then make better decisions at a predetermined level of confidence.

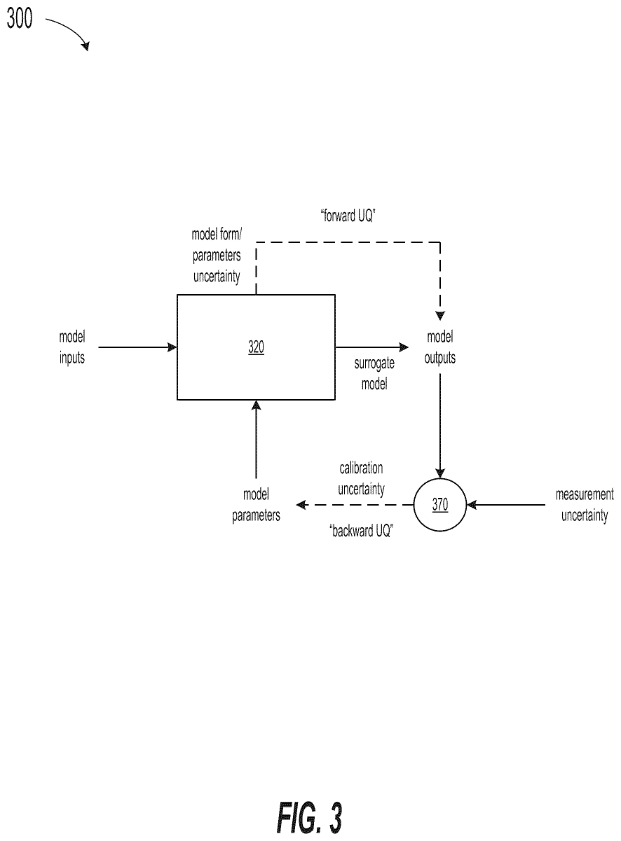

Uncertainty quantification (UQ) aims to estimate the various sources of uncertainty and the resulting uncertainty in the model prediction. UQ can include a variety of activities, such as model verification, sensitivity analysis, calibration, surrogate modeling, model validation, and uncertainty propagation. FIG. 3 shows some of essential components of UQ 300. “Forward UQ” can quantify uncertainty in the model outputs of a model 320 (e.g., the plasma chemistry model 120), given uncertainties in the model inputs, model parameters, and model errors. Model form uncertainty is about the model's ability to capture the relevant system behaviors and may be represented by discrepancy functions. The discrepancy functions can give the predicted discrepancy between the simulation results and experiment results.

“Forward UQ” may include sensitivity analysis (SA) and uncertainty (or error) propagation (UP) and always start with the characterization of the input uncertainties. This information may not be always readily available, and thus expert opinion or user self-assessment has been generally used in the study of the uncertainty, sensitivity and validation.

SA can study the impacts of the input parameters (e.g., the model inputs and model parameters) on the model outputs of the physical model 120 (or a mathematical model), by, for example, local sensitivity analysis and global sensitivity analysis, and provide the importance ranking of the input parameters based on their contribution to output uncertainties. The local sensitivity analysis is to analyze the influence of a single input parameter on the model output, while keeping the remaining input parameters fixed. The global sensitivity analysis aims at quantifying the contribution of individual random input parameter to a quantity of interest (QoI). Presumably, a larger model is likely to give better prediction, because an important reaction pathway is less likely to be omitted erroneously. By contrast, a smaller model can focus the critical attention on a rather small set of processes that have been identified as important. In an embodiment, the uncertainty of the input factors with small importance can be neglected, in order to reduce the dimension of a high-dimensional complex system. In another embodiment, the uncertainty of the importance input factors can be controlled, so that the uncertainty of the model outputs can be reduced, so as to improve the robustness of the model prediction.

UP can measure the impact of disturbances in the input parameters on the model outputs, by analyzing which step(s) is the key factor of the diffusion of uncertainty in a complex model. For example, probabilistic method can be used for uncertain problems when sufficient sample information is available to construct the accurate probability distribution of random model inputs. As another example, non-probabilistic interval process can be used for uncertain problems when there is not enough information to make accurate probabilistic representation of the different types of uncertainties existing in the model.

“Backward UQ” (or inverse uncertainty propagation) is related to model calibration which updates model parameter uncertainty using measurements (which is also uncertain, for example, through physical experiments), by, for example, comparing the simulation results (i.e., the model outputs) and the experiment results using a comparison module 370. In an embodiment, the comparison module 370 can be implemented by a processor, e.g., the simulation processor 130. “Backward UQ” can include model calibration and Bayesian inference. For example, “backward UQ” can reduce the output uncertainty by updating the statistical model (e.g., by adjusting some selected tunable model parameters through estimation, optimization approaches, etc.) using comparisons between computations (or simulations) and experiments (or measurements), and thus improve consistency between the computer models and the physical experiments. The selected tunable model parameters may have obvious influence on the simulation results. Model calibration can be executed deterministically, which determines the point estimates of best-fit model parameters to minimize the difference between code output and experimental data. Model calibration can also be executed statistically.

Bayesian inference can analyze how the uncertainty is transferred from input to output in a complex multilevel model, by, for example, quantifying the uncertainty of the model parameters through a posteriori probability analysis to reduce the difference between experiment results and simulation results.

The slow convergence rate of the simulation-based uncertainty quantification may pose a major challenge in applications where the computational cost of each sample is high. A surrogate model (also known as response surface or meta-model) can provide an approximate functional mapping that replaces the true mapping, and, once being constructed, can be evaluated at negligible computational costs. For example, a surrogate model can include a set of mathematical functions that are easy to evaluate and approximate the actual simulation model based on pairs of input-output samples.

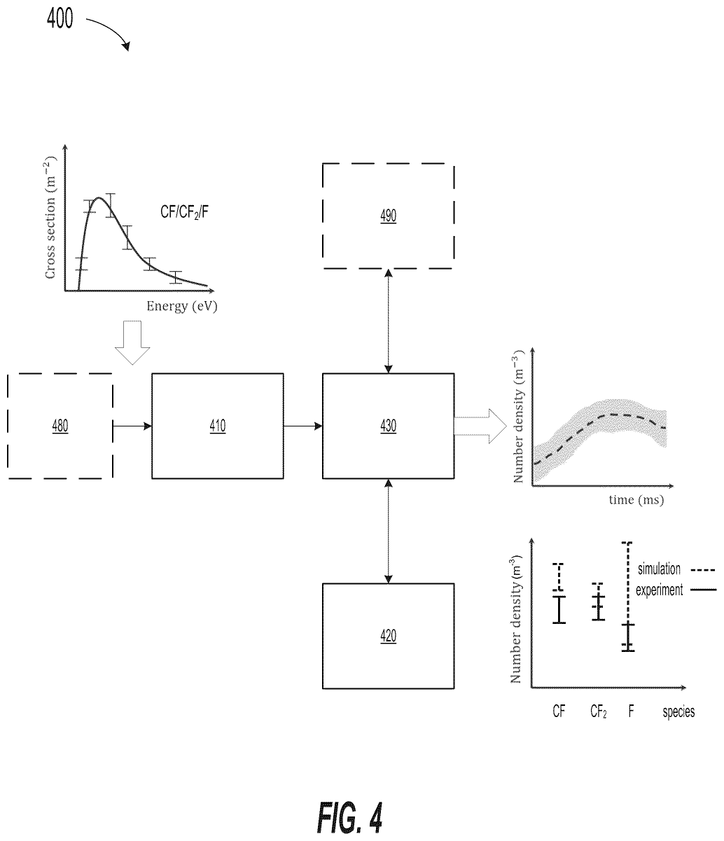

FIG. 4 is a functional block diagram of a computer-based modeling and simulation system 400 in accordance with some embodiments of the present disclosure. The computer-based modeling and simulation system 400 can use simulation techniques (e.g., the UQ 300 shown in FIG. 3) to predict, for example, tool performance during the semiconductor manufacturing tool design process and the densities of plasma species during the plasma chemistry process. As shown in FIG. 4, the computer-based modeling and simulation system 400 can include a data input device 410 (e.g., the data input device 110), a simulation (e.g., computational or mathematical) model (e.g., a plasma chemistry (simulation) model) 420 (e.g., the physical (simulation) model 120), and a simulation processor 430 (e.g., the simulation processor 130). In an embodiment, the computer-based modeling and simulation system 400 can further include a processing tool 480 (e.g., the processing tool 180) that is used to perform the semiconductor process. In another embodiment, the computer-based modeling and simulation system 400 can further include a tool-level library 490 (e.g., the tool-level library 190) for storage of simulation results (e.g., the densities of plasma species).

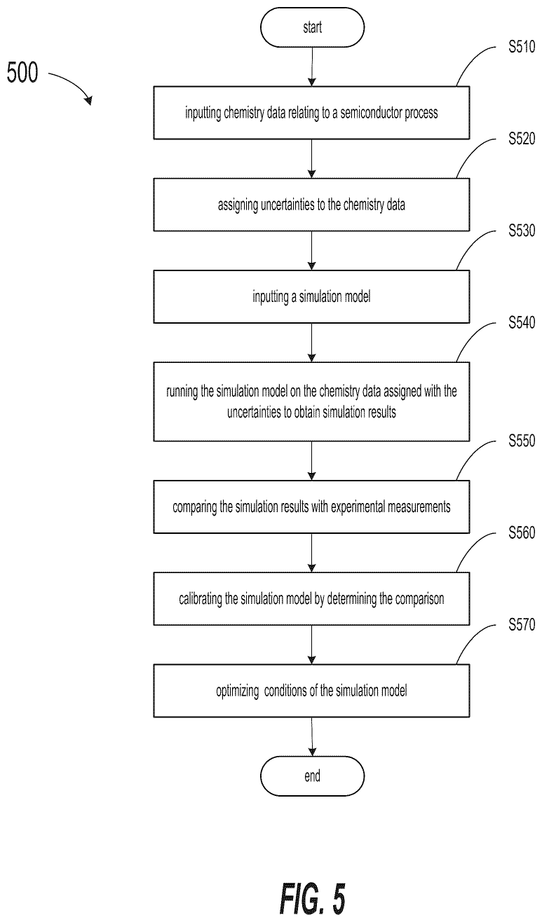

FIG. 5 is a flow chart showing a method 500 for using simulation techniques (e.g., the UQ 300 shown in FIG. 3) to find (e.g., plasma) simulation uncertainties (or error bars) for specific process conditions (recipes) for a semiconductor process (e.g., a plasma chemistry process) in accordance with some embodiments of the present disclosure. The method 500 shown in FIG. 5 may be run on the simulation processor 430 of FIG. 4, for example. As shown in FIG. 5, the method 500 can start in step S510 with the inputting (receiving) of one or more chemistry data related to a semiconductor process, e.g., a plasma chemistry process. In an embodiment, the data input device 110 can be used to collect data (e.g., rate constants of plasma reactions or electron collision cross-sections of plasma species such as CF, CF₂, F, etc.) relating to a semiconductor process (e.g., a plasma chemistry process) and input the collected chemistry data to the simulation processor 130. In an embodiment, the plasma chemistry process can be performed in an atmospheric pressure plasma device (known as a “jet” device). For example, the discharging of the plasma species can be formed in a channel with a small dimension of around 1 mm, and an essentially uniform glow discharge can be formed when the plasma is excited by, for example, applying a radio-frequency voltage (or potential). As feedstock gas passes through the channel, the neural and charged species composition evolves in a quasi one-dimensional manner.

When the gas leaves the channel, excitation of the plasma ceases. In an embodiment, the reacting species may, presumptively, have a Maxwell-Boltzmann distribution of energies with a common temperature, and the rate constant of the species can be assumed to be expressed as a parametric function of this temperature, which may have the extended Arrhenius form as follows:

$$k ( T ) = {AT}^{B} exp ( - \frac{C}{T} ) , \qquad ( 1 )$$

where T is either gas temperature or electron temperature, and A, B and C are coefficients peculiar to each reaction that are to be determined. The uncertainty is assumed to affect only the parameter A.

In step S520, errors (or uncertainties) can be assigned to the chemistry data and input to the simulation processor 430. For aleatory uncertainties, joint density functions (PDF) can be employed to describe or characterize the distribution of the uncertain parameters. For epistemic uncertainties, probability-box, Dempster-Shafer evidence theory or fuzzy theory can be used to reflect the lack of knowledge. Bayesian statistics can be used to handle both aleatory and epistemic uncertainties. In an embodiment, the simulation uncertainty (or error bars shown in FIG. 4) in each chemistry data (e.g., rate constants) in the semiconductor process (e.g., the plasma chemistry process) can be characterized using the log-normal distribution:

$$f ( x ; μ , σ ) = \frac{1}{x σ \sqrt{2 π}} exp ( - \frac{{( ln x - μ )}^{2}}{2 {σ}^{2}} ) , \qquad ( 2 )$$

where the parameters μ and σ are related to the mean x̅ and variance Var(x) of the distribution by

$$μ = ln ( \frac{{\overline{x}}^{2}}{\sqrt{Var ( x ) + {\overline{x}}^{2}}} ) \qquad ( 3 )$$

$$σ = \sqrt{ln ( 1 + \frac{Var ( x )}{{\overline{x}}^{2}} )} \qquad ( 4 )$$

In an embodiment, the rate constant can be in the form of equation (1) and a dimensionless measure of the uncertainty can be ΔA/A, where A is the first coefficient in the Arrhenius rate equation (1), which thus allows that only the parameter A is uncertain and estimates of uncertainty for parameters B and C are not included.

In step S530, a simulation model can also be received and input to the simulation processor 430. For example, a computational or mathematical model that approximates the semiconductor process (e.g., a plasma chemistry process) can be input to the simulation processor 430. While it is shown in FIG. 5 that step S530 follows step S520 and step S520 follows step S510, it is to be understood that the simulation processor 130 may perform steps S510, S520 and S530 simultaneously or in any order different from that shown in FIG. 5.

In step S540, a plasma simulation (based on the simulation model) with sampled parameters can be run on the chemistry data assigned with simulation uncertainties, in order to generate a population of simulation results for each set of input data of interest. In an embodiment, a random value for each rate constant from the prescribed distributions (e.g., log-normal distribution, while other distribution functions can be used to other parameters) can be generated, and the corresponding simulation results (represented by number density (m⁻³) verse time) can be obtained and assembled, as shown in FIG. 4. In this way, the uncertainty in the input chemistry data (e.g., the rate constants) is mapped to uncertainty in the predicted outputs (i.e., the simulation results such as species densities). The simulation results show that the densities of the plasma species (e.g., CF, CF₂ and F) evolve in time under the baseline plasma conditions of the plasma chemistry process. In an embodiment, the prescribed distributions (e.g., log-normal distribution) can be characterized by upper and lower thresholds, and the random value for each rate constant can be generated within a prescribed range limited by the upper and lower thresholds. In some embodiments, steps S510, S520 and S540 can be executed iteratively if a larger population of predictions (or more simulation results) are needed.

In step S550, the simulation results can be compared with experimental measurements with corresponding experimental errors to identify the output parameters that can be safely used for optimization. In an embodiment, interval arithmetic can be used to assess whether the simulation model for specific parameters is in quantitative agreement with the experimental measurements (e.g., characterized by using optical emission spectroscopy (OES), Langmuir probe diagnostics or any other relevant experimental techniques. In an embodiment, the simulation results and the experimental measurements can be characterized by the difference of their means (e.g., simulation and experimental means) and variances (e.g., simulation and experimental variances), as shown by the error bars (e.g., for CF, CF₂ and F) in FIG. 4.

In step S560, the simulation model can be calibrated by determining the comparison of the simulation results with the experimental measurements with the corresponding experimental errors. Verification & Validation (V&V) aims to assess the credibility and establish the quality of the simulation model. Verification quantifies the uncertainties associated with numerical errors generated when using the code to solve the mathematical simulation models, which involves the comparisons of the simulation code with the corresponding exact analytical solution. Validation addresses the model form uncertainty, which involves the comparisons of the simulation results and the experimental measurements. In an embodiment, the simulation model shall be calibrated when the simulation results do not agree with the experimental measurements and, thus, the simulation model does not pass validation. For example, the (simulation) error bar (e.g., that represent the simulation results) for plasma species CF does not overlap with another (experimental) error bar that represents the corresponding experimental measurements, as shown in FIG. 4, and the simulation model is not valid for predicting plasma species CF and, therefore, has to be calibrated in order to make the prediction of plasma species CF. As another example, the simulation model is more suitable for predicting plasma species CF₂ than for predicting plasma species F as the error bar for CF₂ has a smaller variance and a larger portion overlapped with the corresponding experimental measurements (represented by an error bar) than plasma species F's error bar and the error bars for CF₂ and the corresponding experimental measurements have a smaller mean difference than the error bars for plasma species F and the corresponding experimental measurements. In another embodiment, the simulation model may have to be calibrated when a difference between a simulation mean of the simulation results and an experimental mean of the experimental results is greater than a predetermined mean threshold. In some experiments, the simulation model may be not valid for predicting plasma species F and has to be calibrated, as the error bar for plasma species F has too large the variance (e.g., exceeding a predetermined variance threshold).

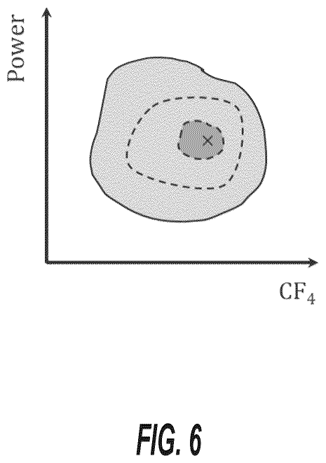

In step S570, optimization techniques can be used to find the optimum plasma conditions (or settings) for those model parameters that satisfy the validation eligibility criteria. The simulation outputs of a simulation model can be used by an optimization strategy to provide feedback on progress of the search for the optimal solution. For example, the plasma conditions can also be assigned with uncertainties (referring to step S520), and the simulation model can be run to adjust and find the optimum plasma conditions. As another example, the optimum plasma conditions of the simulation model for plasma species CF₂ (and C) can be found by applying optimization techniques, such as gradient-based search technique (e.g., finite differences, likelihood ratios (LR), perturbation analysis (PA) and frequency domain method (FDM)), stochastic optimization, response surface methodology (RSM) (e.g., genetic algorithms (GA), evolutionary strategies (ES) and simulated annealing (SA)), statistical methods, etc., in order to optimize the output variables (or results). In an embodiment, the plasma conditions may include the concentration of electrons, ions, atomic and molecular gases, temperatures, distribution functions and/or flow rates in the plasma chemistry process (e.g., oxygen-rich condition or oxygen-poor condition in oxygen containing plasma) (i.e., a semiconductor manufacturing process), the operating power of the plasma chemistry process, and the duty cycle of the operating power. For example, a set of optimization simulations (e.g., an optimization process) can be run on the plasma chemistry model using a distribution to sample model input parameters, and all optimization simulation results can be assembled to find an allowable area with the optimum conditions. As shown in FIG. 6, two input parameters (e.g., the power of the model and the rate constant of the plasma species CF₄) are controlled independently to find all optimum parameters. The allowable area with the optimum conditions is shown by a shaded region in FIG. 6 while the true optimum condition is shown by the cross.

Compared to experimental fine tuning, which is time consuming and expensive and found the best (sub-optimal) recipe that is not always the actual optimum, the method 500, which uses simulation techniques to find simulation uncertainties for specific process conditions for a semiconductor process, can reduce the number of experimental steps and reduce the recipe fine tuning costs. Compared to using pure simulations methods, which do not know what the simulation limitations for specific processing conditions are, the method 500 can quantify the simulation uncertainty and quality of input data. Therefore, the simulations can be limited to cased where initial data sets and models adequately describe the process conditions.

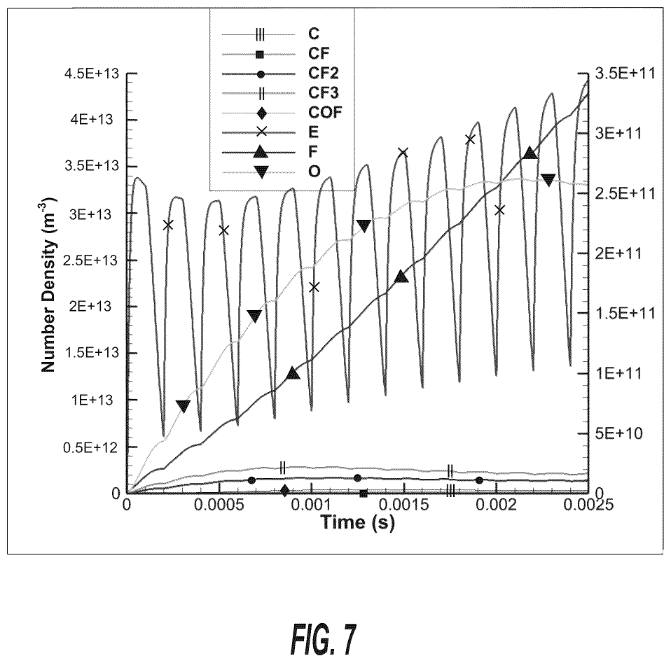

FIG. 7 shows an application example (e.g., global plasma simulations) illustrating the (single) simulation of CF, CF₂, CF₃ and O density for different radicals (or species). In the simulation model, the reactants in the feedstock gases include 50% of CF₄ and 50% of O₂, and a constant power (e.g., 2650 W) is supplied. The plasma chemistry process is quite slow (looking at the rate of decline for CF₄ and the electron density). As shown, radicals (or excited species) may have high production rate, as expected: F, O, O*, O* and O₂ as follows:

$${CF}_{3} + {F}^{-} > {CF}_{2} + F + F \qquad 3 e - 07$$

$${CF}_{3} + {F}^{-} > F + {CF}_{3} \qquad 3 e - 07$$

$${CF}_{3}^{-} + F > F + {CF}_{3} \qquad 2.5 e - 07$$

$${F}^{-} + C > F + C \qquad 2.2 e - 07$$

$$O + {F}^{-} > F + {O}^{*} \qquad 2 e - 07$$

$${F}^{-} + F > F + F \qquad 1 e - 07$$

$${O}_{2}^{-} + F > {O}_{2} + {F}^{-} \qquad 1 e - 07$$

$$O + CF > F + CO \qquad 6.6 e - 11$$

$$O + {CF}_{2} > F + COF \qquad 3.1 e - 11$$

$$O + {CF}_{2} > F + F + CO \qquad 4 e - 12$$

$$O + {CF}_{3} > O + {COF}_{2} \qquad 3.3 e - 11$$

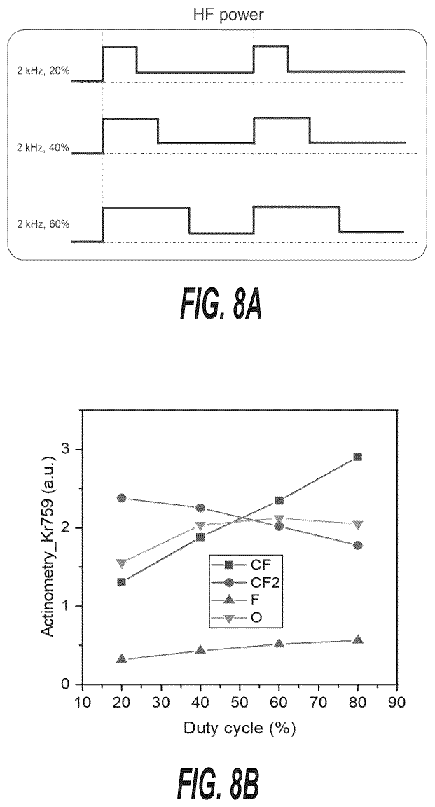

The timeline can be subject to change with specific pulsing schemes. For example, the pulse duty cycle of the supplied power can be tuned finely to be 20%, 40% and 60%, as shown in FIG. 8A. FIG. 8B shows the densities (in terms of the number of photons in a beam determined by an actinometer) of plasma species, e.g., CF, CF₂, F and O, during a plasma chemistry process when different pulse duty cycles of power are supplied. For example, the density of the plasma species CF will be improved if the pulse duty cycle is increased.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

“Substrate” or “target substrate” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a dielectric layer on or overlying a base substrate structure such as a thin film. Thus, substrate is not limited to any particular base structure, underlying dielectric layer or overlying dielectric layer, patterned or un-patterned, but rather, is contemplated to include any such dielectric layer or base structure, and any combination of dielectric layers and/or base structures. The description may reference particular types of substrates, but this is for illustrative purposes only.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A method, comprising:
receiving a simulation model related to a semiconductor process;
receiving one or more input data related to the semiconductor process;
assigning uncertainty to each of the input data;
running the simulation model on the input data assigned with the uncertainties to obtain simulation results;
comparing the simulation results with experimental measurements;
calibrating the simulation model based on comparing the simulation results with the experimental measurements; and
running an optimization process with input uncertainties to obtain an allowable area of optimum parameters.

2. The method of claim 1, wherein the simulation results are represented by a simulation error bar that is determined according to a simulation mean and a simulation variance of the simulation results, the experimental measurements are represented by an experimental error bar that is determined according to an experimental mean and an experimental variance of the experimental results, and the simulation model is calibrated based on a relationship of the simulation error bar with the experimental error bar.

3. The method of claim 2, wherein the simulation model is calibrated when the simulation error bar does not overlap with the experimental error bar.

4. The method of claim 2, wherein the simulation model is calibrated when a difference between the simulation mean and the experimental mean is greater than a predetermined mean threshold.

5. The method of claim 2, wherein the simulation model is calibrated when the simulation variance is greater than a predetermined variance threshold.

6. The method of claim 1, wherein the semiconductor process is a semiconductor manufacturing process, the input data is a rate constant of a plasma reaction or electron collision cross-section of plasma species that participate in the semiconductor manufacturing process, chamber geometry, and/or input conditions, the simulation results are a specie density of the plasma species that evolves in time under certain plasma conditions of the semiconductor manufacturing process, temperatures of plasma species, and/or distribution functions, and the experimental results are characterized by using optical emission spectroscopy (OES) or Langmuir probe diagnostics.

7. The method of claim 6, wherein the rate constant is a value sampled randomly from a predetermined distribution that characterizes the rate constant of the plasma species.

8. The method of claim 7, wherein the rate constant is characterized by a log-normal distribution.

9. The method of claim 7, wherein the predetermined distribution is characterized by an upper threshold and a lower threshold, and the rate constant is sampled randomly within a range of the predetermined distribution that is limited by the upper threshold and the lower threshold.

10. The method of claim 7, wherein calibrating the simulation model includes adjusting a range of the predetermined distribution that the value is sampled randomly therewithin.

11. The method of claim 6, further comprising:
determining optimum plasma conditions of the simulation model for the simulation results that are in quantitative agreement with the experimental measurements.

12. The method of claim 11, wherein the optimum plasma conditions are determined by assigning uncertainties to the certain plasma conditions of the simulation model, running the simulation model using the certain plasma conditions assigned with the uncertainties to obtain optimum simulation results, and comparing the optimum simulation results with optimum experimental measurements.

13. The method of claim 12, wherein the optimum plasma conditions include concentrations of electrons, ions, atomic and molecular gases, temperatures, distribution functions and/or flow rates in the semiconductor manufacturing process.

14. The method of claim 12, wherein the optimum plasma conditions include operating power of the semiconductor manufacturing process.

15. The method of claim 14, wherein the optimum plasma conditions include a duty cycle of the operating power.

16. The method of claim 1, wherein receiving the one or more input data, assigning the uncertainty to each of the input data and running the simulation model are executed iteratively more than one time.

17. The method of claim 1, wherein receiving the simulation model and receiving the one or more input data are executed simultaneously.

18. The method of claim 1, wherein receiving the simulation model is executed following receiving the one or more input data.

19. The method of claim 1, wherein receiving the one or more input data is executed following receiving the simulation model.

20. The method of claim 1, wherein running the optimization process with input uncertainties to obtain the allowable area of optimum parameters is executed more than one time to produce the allowable area of optimum parameters.
